(19) United States
(12) Patent Application Publication
(10) Pub. No.: US 2026/0126320 A1
(43) Pub. Date: May 7, 2026

(54) Acoustic Communication

(71) Applicant: Elliptic Laboratories ASA, Oslo (NO)

(72) Inventor: Espen KLOVNING, Strømmen (NO)

(73) Assignee: Elliptic Laboratories ASA, Oslo (NO)

(21) Appl. No.: 19/118,766

(22) PCT Filed: Nov. 16, 2023
(86) PCT No.: PCT/NO2023/060096

§ 371 Date: Apr. 5, 2025

(30) Foreign Application Priority Data
Nov. 18, 2022 (NO) 20221244

(51) Int. Cl. G01H 3/06

(52) U.S. Cl. CPC G01H 3/06

(57) ABSTRACT

The present invention relates to an electronic device including an acoustic transducer for transmitting an acoustic signal at a predetermined frequency toward a second electronic device. The device including an inertia measuring unit configured to measure change in direction and movement of the device relative to the second device. The device also has a calculation unit configured to calculate the Doppler shift resulting from the movement and adjusting the transmitted and/or received frequency according to the calculated Doppler shift.

The present invention is related to electronic devices at least partially communicating using sound, specifically ultrasound signals.

It is known to track an object for touchless interaction with a computing device with an ultrasonic transmitter and a number of receivers using time-of-flight measurements. Indeed various proposals for such tracking have been made—e.g. in US patent application U.S. 2006/0161871 by Apple, which relates particularly to input to a handheld device by a user's finger. However, these proposals have shortcomings. In particular, they can be sensitive to interference from echoes caused by other objects and from active sources of noise.

Interference is particularly problematic in acoustic tracking systems due to the wider dispersion characteristics and speed of sound waves.

In U.S. Pat. No. 10,331,166 this the situation is discussed where two or more devices, especially mobile devices, attempt to use acoustic input systems within audible range of each other. They are likely to interfere with each other, especially when they are configured to transmit similar or identical acoustic signals to each other (e.g. in the same frequency range). In U.S. Pat. No. 10,331,166 a solution has been proposed where two devices can interact by one of the devices receiving and acting on an acoustic signal from the other. One simplistic example might be for the second device to alert a user to the presence of another user (of the first device) in the vicinity, e.g. any user or any that can be identified, or any with an identity in the second device's phonebook.

In the Office Action the Examiner is of the opinion that the present application lack inventive step over JP2015185950A (D1) and US2019/0204408 A1 (D2).

In JP2015185950A and US2019/0204408 calculation of the Doppler shift is used for adjusting for relative movement in a communication based on acoustic signals. In JP2015185950A a global positioning system, reflected electromagnetic waves, or similar, is used for measuring position and speed and then is used to adapt the frequencies of the acoustic signals. In US2019/0204408 the Doppler shift is measured based on signals between two devices, thus requiring an already established relationship between the two devices.

The solution in the prior art is, however, still vulnerably to disturbances and loss of contact between the devices, especially on mobile devices moving relative to each other. It is therefore an object of the present invention to improve the accessibility and stability of the acoustic communication between at least two devices. This is achieved as presented in the accompanying claims.

The present invention is primarily described in relation to the use of an inertia measurement in each mobile phone. As inertial or acceleration measurements differ from the direct measurement of relative speed as you adjust the signal when you measure a change, and the magnitude of the change, and do not monitor the relative speed or position. Thus, the present invention only compensates for changes in relative movement when a change in movement or position is registered in one of the devices.

Thus the present invention is aimed at the problem where the devices are moving relative to each other. When using ultrasound signals the movement may be sufficiently large to alter the frequency received at the devices due to the Doppler shift. While a narrow frequency range may be advantageous in order to filter out ambient noise the Doppler effect is more evident with a narrow frequency range.

Also, in a case where more than one frequency is used transmitting the acoustic signal, e.g. as described in NO20221245 [P6567], the signals will usually have to be separated by 150-200 Hz so as to avoid overlapping frequencies when the devices move relative to each other. Compensating for the relative movements will reduce this problem and provide a more efficient use of the frequency range, for example allowing more parallel signals at different frequencies.

According to the present invention the transmitted acoustic signals that are intentionally varied with device movement in a specific direction to remove or significantly reduce the doppler effect observed by receiving devices.

The present invention will be described below with reference to the accompanying drawings, illustrating the invention by way of examples.

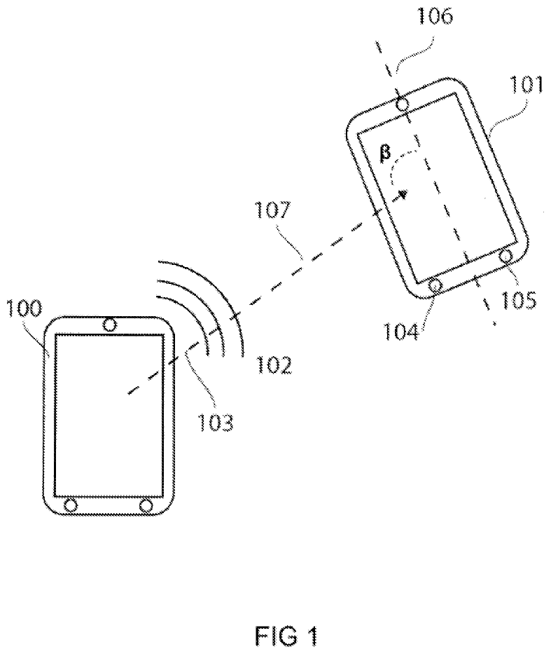

FIG. 1 illustrates the concept of the present invention with two electronic devices communicating as discussed in U.S. Pat. No. 10,331,166

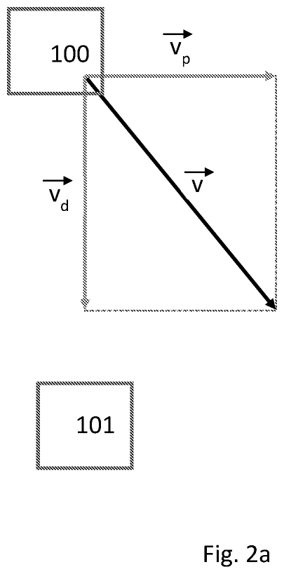

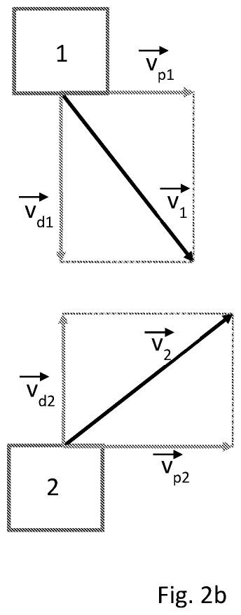

FIG. 2 a, b illustrates the relative movement vectors between the two devices.

As illustrated in FIG. 1 electronic devices 100, 101 equipped with acoustic components to send and receive acoustic signals 102 which may be signals with a single sine or a plurality of frequencies to encode and transfer data between the electronic devices. The acoustic signal 102 could also be used as an identifiable acoustic signal with a fixed set of frequencies that the receiving devices rely on for proper handling during receive processing.

If a first electronic device 100 is transmitting a sine signal from a transmitter 108 with a frequency F1 while moving from or towards a second device 101 in the direction 103 toward the second device capable of receiving the transmitted signal in at least one acoustic receiver 104,105, the second device will, due to the Doppler effect, observe another frequency F2 being different from the F1 frequency the first device was transmitting. This usually means that two electronic devices 100,101 where at least one of them for example is mobile phone or a tablet need to take the doppler effect into account when using acoustic signals with one or more frequency components to transfer information using the acoustic signal or the intent of the specific acoustic signal with frequency F1 from a mobile device to another device.

In essence, the original frequency or plurality of frequencies of the acoustic signal may be slightly altered when it is received. The F2 frequency may be lower or higher than the originally transmitted frequency F1. How much lower or higher will depend on how fast the first device is moving towards the second device. If both devices are moving towards or away with each other, the Doppler shifts of the transmitted frequency will depend on the relative speed of the two devices. Although the description discusses two devices communicating using acoustic signals, the present invention can be used for a plurality of devices.

There are situations where the Doppler shift is causing problems with identifying the exact frequency that the first device was using. If the exact frequency is used to transfer information (i.e. bits, numbers, symbols, characters, data, etc) between the first and second device, it would be easier if the devices were static and there would be no Doppler shift in the acoustic signals but the observed frequencies in the receivers would not change. In a receiver, dealing with a constant frequency is an obvious advantage compared to a solution where the frequencies would change ever so slightly because the first device is moving.

Usually, embedded sensors such as accelerometer and gyroscope or other 6-Degrees-of-freedom sensors are ubiquitous in mobile devices. According to the present invention at least the mobile device 100 includes such sensors and is configured to detects the direction and amount of movement toward the second device 101 that is transmitting data using acoustic signals (e.g. ultrasonic signals). This solution is described in detail in U.S. Pat. No. 10,331,166. As an alternative to the use of inertia measurements in each device it may also be contemplate to use more broadband signals transmitted and received by the devices to directly measure any change in the distance between the devices base on time of flight measurements, the different types of sensors being referred to below as inertia measuring units (IMU), Once the first device 100 knows the direction 103 to the second device 101, it can use its own IMU sensors to continuously detect its own speed in the direction of the second device and dynamically adjust the frequencies of the acoustic signals to remove or significantly reduce the observed Doppler shift by the second device. Even if the first device does not move directly towards the second device, the speed can be divided in two components, that is, speed towards the second device and speed perpendicular to the direction of the second device.

This is illustrated in FIG. 2 a, where the total movement of the first device V has a component Vd toward the second device 101, and the transmitted signal frequency is adjusted according to Vd so that the second device 101 receives the predetermined frequency.

If the second device is also moving as illustrated in FIG. 2b, the first device needs to continuously track the direction to the second device and simultaneously calculate its own speed in the direction of the second device to adjust the acoustic signal and its frequency accordingly to remove or reduce the doppler effect. If the second device is also moving while receiving data from the first device, it needs to detect the direction to the first device and calculate its own speed in that direction. With this speed estimate, it could adjust the frequency components used for sampling of the incoming acoustic signal and remove or significantly reduce the observed Doppler effect. If the first device is not moving, the frequency components of the acoustic signals that are transmitted towards the second device will not be adjusted for Doppler effect due to the first device being static.

In the discussion above the devices are primarily set to detect movement and adjust the signal relative to a common, global reference. If the devices are capable of calculating the relative movement between the devices, e.g. as described in NO20221246 [P6728], where differences in propagation time for acoustic signals between at least one transducer, e.g. a speaker, on a first device and at least two transducers, e.g. microphones on a second device, are used for finding the relative position and/or orientation, and NO2022147 [6750], where the communication between two devices are initiated at the registration of a movement in one device, the devices may be adapted to use a common, doppler corrected, frequency, e.g. communicated using a wireless communication network.

If the applied frequency range is close to the audible range the devices may be configured to avoid moving the frequency into audible range due to movement towards users.

In one embodiment of the present invention, the first device is a personal device (e.g. smart watch, smartphone, tablet, laptop) and the second device is video conferencing system in an limited space or room in an office building. The audio/video conferencing system may continuously send out acoustic signals containing some information about the conferencing system. If there is a motion or presence detection scheme running in the room or limited space, the system can start sending out acoustic signals containing the information about the conferencing system once someone enters the detection area. If the first device needs to send some information to the second device about the first device or the user of the first device, it can do that using acoustic signals where the Doppler effect is removed or significantly reduced.

In another embodiment, where the first device does not have embedded movement sensors with six degrees of freedom, and is therefore not capable of detecting its own speed, it could use the acoustic signals from the second device or send out its own acoustic signals to detect when the device is no longer moving by processing the received acoustic signals to identify the resulting echos of static objects in the vicinity of the first device from the probe signal in the acoustic receiver over a time period. When that happens, the first device can initiate its own data transmission to the first device without worrying about Doppler effect.

To summarize the present invention relates to an electronic device and a system including at least two devices, where the electronic device includes an acoustic transducer for transmitting an acoustic signal at a predetermined frequency toward a second electronic device. The device also comprises a movement measuring device configured to measure the direction and movement relative to the second device. The device includes a calculation unit configured to calculate the Doppler shift resulting from the movement and adjusting the transmitted and/or received frequency according to the calculated Doppler shift so as to maintain the frequency relative to the second device or a stationary, global reference system. Thus, the transmitter may adjust the transmitted frequency and/or the receiver may adjust the filter or sampling rate to receive the doppler shifted signal.

The acoustic signal is preferably in the ultrasound range and the device may be configured to avoid the audible acoustic range. This may be obtained by adjusting the receiver in stead of the transmitter frequency.

Two or more devices may be part of a communication system being configured to measure the relative movement between the devices and to adjust the common acoustic frequency according to the measured relative movement. The devices may also include communication means being configured to choose a frequency suitable for both devices.

1-8. (canceled)

9. An electronic device comprising an acoustic transducer for transmitting an acoustic signal at a predetermined frequency toward a second electronic device for providing a communication between the devices, the electronic device including sensors configured to receive an acoustic signal from the second electronic device and to detect the direction toward the second electronic device, and an inertia measuring unit configured to measure acceleration relative to the direction toward the second electronic device resulting in a change in the relative movement, the electronic device having a calculation unit configured to calculate the Doppler shift resulting from the amount of movement in the direction relative to the second electronic device and adjusting at least one of the transmitted and received frequency according to the calculated Doppler shift.

10. The electronic device according to claim 9, wherein the electronic device comprises an acoustic receiver, the calculating unit being configured to adjust the sampling rate of the receiver according to the calculated Doppler shift.

11. The electronic device according to claim 9, wherein the acoustic signal is in the ultrasound range.

12. The electronic device according to claim 11, wherein calculation unit is configured to avoid the acoustic range when adjusting the signal.

13. The electronic device according to claim 9, wherein the electronic device is configured to measure the movement relative to a stationary reference system.

14. The electronic device according to claim 9, wherein the inertia measuring unit comprises an accelerometer.

15. A communication system including at least two electronic devices according to claim 9, the electronic devices being configured to measure the relative movement between the electronic devices and to adjust transmitter and receiver to the common acoustic frequency according to the measured relative movement.

16. The communication system according to claim 15, wherein the devices include communication means being configured to choose a frequency suitable for both devices.
